(19) United States
(12) Patent Application Publication
(10) Pub. No.: US 2006/0288185 A1
(43) Pub. Date: Dec. 21, 2006

(54) System and method for implementing a common descriptor format

(75) Inventors: Matthew P. Brisse, Cedar Park, TX (US); Winston Bumpus, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/156,154

(22) Filed: Jun. 17, 2005

(51) Int. Cl. G06F 12/00

(52) U.S. Cl. 711/170

(57) ABSTRACT

A system and method is disclosed for the implementation of a common descriptor format for storage data formats regardless of the storage media. An example storage medium using a common descriptor format may comprise data stored on the storage medium and a common descriptor that is associated with the stored data and stored on the storage medium. The common descriptor may include formatting information stored in a standardized format. The formatting information may be sufficient to describe how the data is formatted.

### TECHNICAL FIELD

The present disclosure relates generally to computer systems and information handling systems, and, more specifically, to a system and method for implementing a common descriptor format for storage data formats regardless of the storage media.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include a storage system or a storage network for managing active data. Users of the information handling system may want to create a copy of this active data for archival or backup purposes or to free space on the storage system for more active data. New regulatory requirements in certain industries require users to keep their data archives for 10, 20, and even 50 years. Moreover, many entities have non-regulatory reasons for keeping long-term archives. For example, hospitals may need to preserve medical files, such as X-rays and Computerized Axial Tomography Scans (CAT scans), for the lifetimes of their patients; oil companies may keep geophysical data on their various holdings in the hopes that future technologies will lead to new discoveries; and governments may need to keep personal records, such as birth certificates, for the life of their subjects. As suggested by Moore's Law, however, the computing industry's continued improvements to information handling systems results in a rapid transition from state-of-the-art to obsolescence for many technologies, including storage systems. Once-common media formats become inaccessible over time as software is updated, hardware replaced, vendor support expires, and personnel change. Often, although the media on which the data is stored may have an extended shelf life, the data itself may become unreadable.

Storage vendors' practices of using proprietary storage formats for data only exacerbate this problem. Some users migrate their duplicate data to new storage systems as they replace the original storage formats in an effort to keep their data readable by current systems. Data formats change over time even if the same vendor applications and same hardware, however, forcing the customer to migrate their data to the new data format. Moreover, a user may desire to change from one vendor solution to another for a reason not associated with storage format or obsolescence problems, again forcing the user to incur the costs of full-scale data migration. The costs of such migration will only increase as storage systems age. Customers can be locked into a single vendor's storage programs simply because they do not want to invest the money for migration. If their chosen vendor goes out of business or otherwise does not maintain its data-file format, the user can be left without a reasonable solution when their hardware fails and their old software will not work with new hardware. Some users have resorted to preserving entire information handling systems, including both hardware and software components, with their copies of data to ensure that at least one such system will be able to read the data in the future. These practices are costly and time-consuming, but without them, duplicate copies of data might be lost due to the inability of current systems to view the data.

### SUMMARY

In accordance with the present disclosure, a system and method is disclosed for the implementation of a common descriptor format for storage data formats regardless of the storage media. An example storage medium using a common descriptor format may comprise data stored on the storage medium and a common descriptor that is associated with the stored data and stored on the storage medium. The common descriptor may include formatting information stored in a standardized format. The formatting information may be sufficient to describe how the data is formatted. An example method for writing data on a storage medium using a common descriptor format may include the step of writing the common descriptor on the storage medium and the step of writing the data in the format described in the common descriptor. One embodiment of the method for reading data on a storage medium using a common descriptor format may include the step of reading the common descriptor on the storage medium and the step of using the description of how the data is formatted in the common descriptor to read the data.

The system and method described herein is technically advantageous because it provides a system and method through which data can be read using the formatting information in the common descriptor, regardless of the data format, chipset, operating system, storage media, or the vendor. Because of this technical advantage, data stored in an obsolete or undesirable format can be accessed by current programs made by any vendor and read in-place, without an expensive migration. Thus, although a first program from a first vendor may generate the data format used to store the data, a second program from a second vendor can use the common descriptor formatting information in the common descriptor to determine how to read the stored data. As a result, users can continue to access their stored data in its existing media, even if they later make fundamental changes to their system, such as installing new hardware or new operating system software, without losing access to their stored data. Likewise, users can switch from one storage vendor solution to another without migrating their data to the new file format. The users can thus not only preserve their investment in the physical assets of their storage systems but also avoid incurring the costs associated with large-scale data migrations.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of a sample storage system;

FIG. 2 is a block diagram of a sample descriptor file and sample data file;

FIG. 3 is a block diagram of a sample descriptor file;

FIG. 4 is a flowchart illustrating a sample method for generating a descriptor file and associated data file; and

FIG. 5 is a flowchart illustrating a sample method for reading a descriptor file and associated data file.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

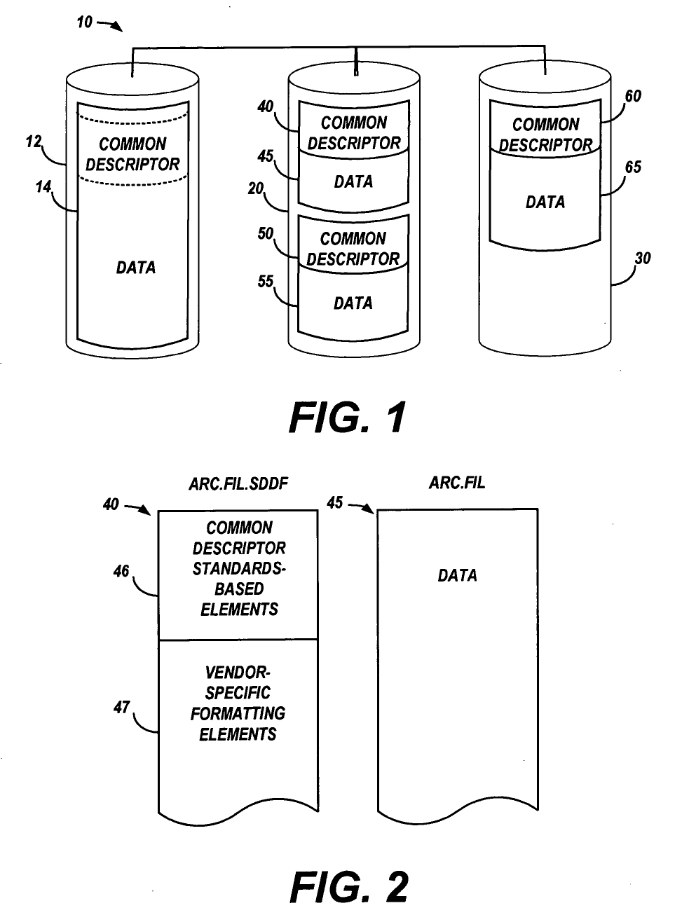

A common descriptor format, or “CDF” may be used to inform a user of a storage system, which may be a component of an information handling system, how to read stored data. In some situations, the common descriptor may be embedded within a data file or within a data stream. Thus, as shown in FIG. 1, a storage system 10 having a drive 12 may store data 14 with an embedded common descriptor. The embedded common descriptor, may, for example, be a header at the beginning of the data. In other cases, particular data files may be associated with a common descriptor file, so that the user can determine the format for multiple files in multiple formats stored in a single storage medium. The common descriptor may therefore reside on the storage medium containing the associated data. To that end, the example storage system 10 shown in FIG. 1 has two drives 20 and 30 that store three common descriptor files 40, 50, and 60; each common descriptor file has an associated data file, labeled 45, 55, and 65, respectively. For the purposes of this example, storage system 10 includes only three drives, which may be hard drives, removable media drives, or any other storage hardware, but as a person of ordinary skill in the art having the benefit of this disclosure will realize, storage system 10 may include any number of hardware components. Likewise, storage system 10 may include a storage network with storage servers or other network-based hardware components. Storage system 10 may include any number of data files with embedded common descriptors or data and common descriptor file pairs, also as a person of ordinary skill in the art having the benefit of this disclosure will realize.

The format for a common descriptor, such as, for example, descriptor file 40, preferably will be standardized throughout the computing industry to allow an end user to access data using a software program that is different from the program that originally stored the data. A common descriptor format, however, will not impose a standard format for the data associated with any common descriptors. Rather, the standard format may allow for a common methodology for the existence of a profile that describes the data format. An example descriptor file 40 preferably may be written Extensible Markup Language (“XML”) so that a specific application programming interface (“API”) will not be necessary to read descriptor file 40.

The common descriptor format essentially allows for a basic level of interoperability between storage file formats and storage vendors. The common descriptor format would not preclude a proprietary method for data distribution but instead would enable any compliant software or controller vendor to access the common descriptor that describes the structure underlying the associated data. This structure would likely be a vendor plug-in if the vendor views its data structure as proprietary or a competitive advantage.

FIG. 2 illustrates the contents of a sample common descriptor file 40, which is associated with data file 45. Again, however, the common descriptor may be embedded within stored data, as shown in drive 12 of FIG. 1. Common descriptor file 40 and data file 45 may have file formats for the name, such as “Arc.fil.sddf” for common descriptor file 40 and “Arc.fil” for data file 45. The storage system industry may preferably agree to locate the common descriptor file at the same place in every media, such as at the first byte. Common descriptor file 40 may include a set of common descriptor elements 46 and a set of vendor-specific formatting elements 47. Set of common descriptor elements 46 may include the standardized information needed to read the common descriptor file and the core elements that describe data file 45. The core elements may be the needed to describe any and all data formats, as discussed later in this disclosure. Set of vendor-specific formatting elements 47 will preferably include a collection of elements that describe the formatting of the particular data file 45 in question. These elements will likely be unique to each vendor and may define the structure needed to read the specific data format used by that vendor. All vendors, however, will preferably use the same terms to describe their specific data formats. That is, vendors may use universally accepted verbs and nouns to describe the data format, but a vendor may organize those verbs and nouns to form the vendor-specific formatting elements that describes a data format unique to that vendor.

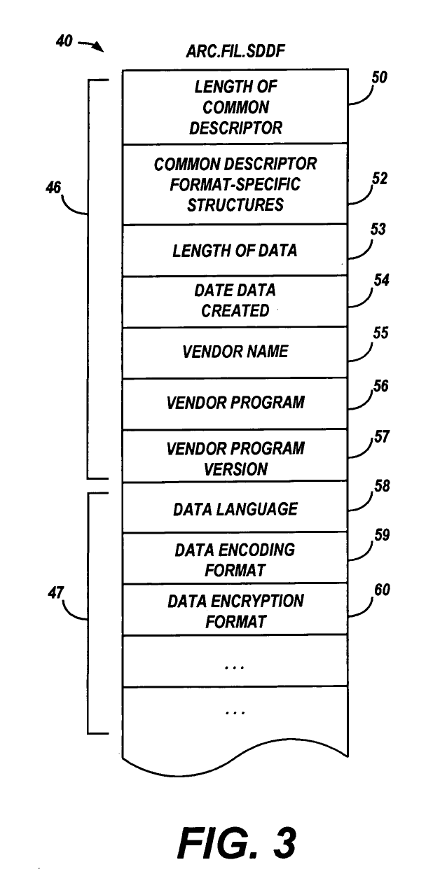

FIG. 3 shows common descriptor file 40, with the set of common descriptor standards-based elements 46 and set of vendor-specific formatting element 47 broken out into more detail. Subset of common descriptor standards-based elements 46 may include a data block 50 listing the length of the common descriptor and a data block 52 that includes other common descriptor format-specific structures, if necessary. Subset of common descriptor standards-based elements 46 may also include the core elements needed to describe data file 45, as discussed above. Thus, as shown in FIG. 3, subset of common descriptor standards-based elements 46 may also include a data block 53 listing the length of data file 45 and a data block 54 stating the date data file 45 was created. Subset of common descriptor standards-based elements 46 may also include a data block 55 listing the name of the vendor associated with the program used to create data file 45, a data block 56 listing the name of that program, and a data block 57 listing the version of that program. Subset of common descriptor standards-based elements 46 may include more or fewer data blocks, as a person of ordinary skill in the art having the benefit of this disclosure will realize. The elements and formatting of these subsets, which form set of common descriptor standards-based elements 46, will preferably be standardized across the computing industry. This standardization will permit the data of the common descriptor file to be universally readable across vendors and programs.

FIG. 3 also shows a breakdown of the elements that form set of vendor-specific formatting elements 47. As discussed earlier in this disclosure, the contents of set of vendor-specific formatting elements 47 will differ from vendor to vendor, although preferably, the terms used to describe the various formatting elements will be common to all vendors. Set of vendor-specific formatting elements 47 may include a data block 58 listing the language used to write data file 45, a data block 59 listing the encoding format for data file 45, and a data block 60 listing the encryption format for data file 45. The elements shown in FIG. 3 are not the complete range of possible elements that could be included in set of vendor-specific formatting elements 45. Rather, set of vendor-specific formatting elements 45 may include more or fewer elements, as needed to describe the vendor-specific data format. For example, some vendors may not encrypt their data and therefore may not require data block 60 in their set of vendor-specific formatting elements 45. Likewise, some vendors may want to include an additional data block, not shown in FIG. 3, that lists any compilation information associated with data file 45. As a person of ordinary skill in the art having the benefit of this disclosure will realize, common descriptor file 40 as a whole may include more or less information, so long as enough information remains in the common descriptor file to determine how to read the data file associated that is with common descriptor file, and so long as common descriptor file 40 conforms to any standardized requirements adopted by the computing industry. Again, a common descriptor may also be embedded in the stored data instead of stored as a separate file associated with the data file.

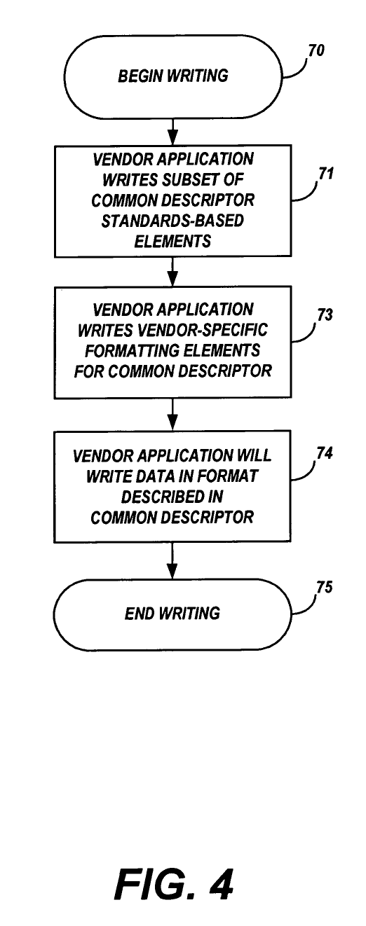

The common descriptor format could be implemented in two phases. The first phase would include vendor identification and creation of the basic common descriptor format. In the second phase, vendors would incorporate into their storage systems the plug-ins that would generate the common descriptors, allowing vendor interoperability. Once the two phases are completed, the end user may create data with common descriptors using a method similar to the one depicted in the flowchart shown in FIG. 4. The writing process begins at block 70 of the flowchart. The vendor application used to write the data, which may be any storage-writing application, will first write the contents of the subset of standards-based elements for the common descriptor, as shown in block 71. The vendor application will next write the contents of the set of vendor-specific formatting elements of the common descriptor, as shown in block 73. As shown in block 74, the vendor application will then write the data in the format described in the newly written common descriptor. At this point, the vendor application will have completed writing the common descriptor and the data, as shown in terminal block 75.

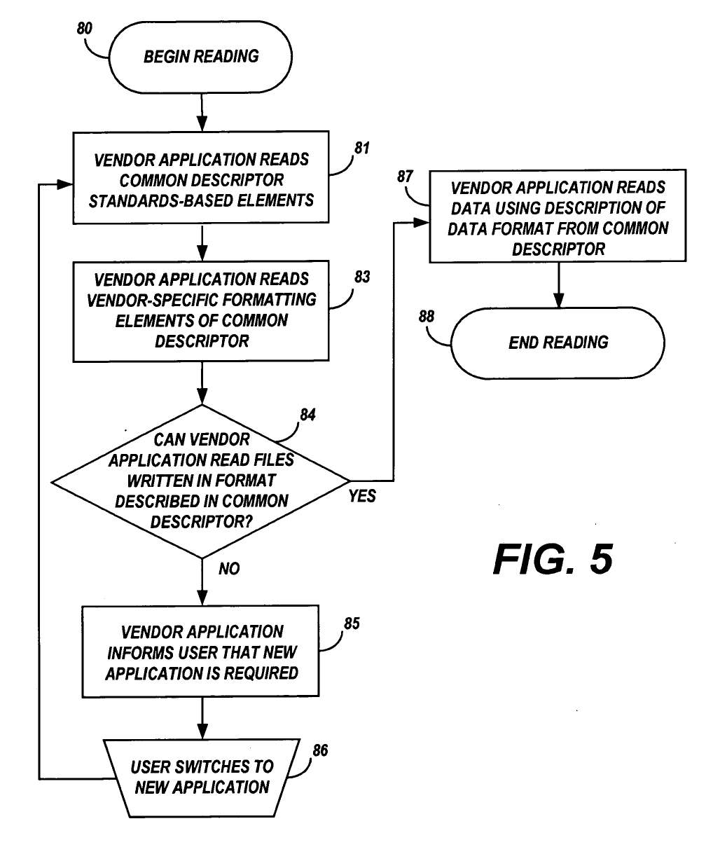

FIG. 5 shows a flowchart setting forth a method for reading stored data. A vendor application, which may or may not be the same application used to write the data, will begin the reading process at the block 80 depicted in FIG. 5. The vendor application will first read the subset of standards-based elements, as shown in block 81. These elements may tell the vendor application the location of the descriptor file. Again, the subset of standards-based elements preferably may be located at the same location for all data. In block 83, the vendor application will read the set of vendor-specific formatting elements, which will then describe the format of the data in more detail, as described earlier in this disclosure. Using the information learned from reading these elements, the vendor application will ask itself whether it can read data written in the format described in the common descriptor, as shown in block 84. If the answer is yes, the vendor application will use the format information from the common descriptor to guide it in reading the data, as shown in block 87 of the flowchart in FIG. 5. At this point, the vendor application will reach terminal block 88 and end reading the data. If the vendor application cannot read the data, the vendor application will inform the user that a new application is needed, as shown in block 85. At the time, the user must switch to a new vendor application to read the data, as shown in block 86. This new application will begin the reading process anew at block 81, as shown in FIG. 5.

The example systems and methods for implementing a common descriptor format described herein has been described with reference to pairs of common descriptor files and data files, and common descriptors embedded within data, but it should be recognized that a single common descriptor file could be used for each individual storage disc or individual storage medium, regardless of the number of data files on that disc or medium. This common descriptor file could, for example, describe a generic file format for a vendor, with a standardized length, language, and location for each data file. Then every data file on that particular disc or medium would conform to the common descriptor format included on the disc, holographic media, memory, or other storage medium. Each disc would require a specific common descriptor file in this example of the system and method for implementing common descriptor format. Although the present disclosure has been described in detail, it should be understood that various changes, substitutions, and alterations can be made hereto without departing from the spirit and the scope of the invention as defined by the appended claims.

What is claimed is:

1. A storage medium using a common descriptor format, comprising:
data stored on the storage medium, and
a common descriptor associated with the stored data and stored on the storage medium, wherein the common descriptor includes formatting information stored in a standardized format, and wherein the formatting information is sufficient to describe how the stored data is formatted.

2. The storage medium using a common descriptor format of claim 1, wherein:
the data is stored on the storage medium as a data file, and
the common descriptor associated with the stored data is stored as a separate common descriptor file associated with the data file.

3. The storage medium using a common descriptor format of claim 1, wherein the common descriptor is embedded in the data.

4. The storage medium using a common descriptor format of claim 1, wherein the common descriptor is written in Extensible Markup Language.

5. The storage medium using a common descriptor format of claim 1, wherein the common descriptor includes a set of standardized elements describing how the common descriptor is formatted.

6. The storage medium using a common descriptor format of claim 1, wherein the common descriptor includes a set of vendor-specific elements describing vendor-specific formatting features for the data.

7. The storage medium using a common descriptor format of claim 6, wherein the set of vendor-specific elements uses standardized terms to describe the vendor-specific formatting features for the data.

8. The storage medium using a common descriptor format of claim 1, wherein the common descriptor includes a data block describing how long the common descriptor is.

9. The storage medium using a common descriptor format of claim 1, wherein the common descriptor includes a data block describing how long the data is.

10. The storage medium using a common descriptor format of claim 1, wherein the common descriptor includes a data block describing when the data was created.

11. The storage medium using a common descriptor format of claim 1, wherein the common descriptor includes a data block describing which software vendor is associated with the data.

12. The storage medium using a common descriptor format of claim 1, wherein the common descriptor includes a data block describing which software program is associated with the data.

13. The storage medium using a common descriptor format of claim 12, wherein the common descriptor includes a data block describing which version of the software program is associated with the data.

14. The storage medium using a common descriptor format of claim 1, wherein the common descriptor includes a data block identifying whether the data is encrypted.

15. A method for writing data on a storage medium using a common descriptor format, comprising the steps of:
writing a common descriptor on the storage medium, wherein the common descriptor includes formatting information in a standardized format that is sufficient to describe how the data is formatted, and
writing the data in the format described in the common descriptor.

16. The method for writing data on a storage medium using a common descriptor format of claim 15, wherein the step of writing a common descriptor on the storage medium comprises the step of writing a set of standards-based elements for the common descriptor, wherein the standards-based elements for the common descriptor includes data describing how the common descriptor is formatted.

17. The method for writing a data file on a storage medium using a common descriptor format of claim 15, wherein the step of writing a common descriptor on the storage medium comprises the step of writing a set of vendor-specific formatting elements for the common descriptor, wherein the vendor-specific formatting elements utilize standardized terms to describe vendor-specific formatting features for the data.

18. A method for reading data on a storage medium using a common descriptor format, comprising the steps of:
reading a common descriptor on the storage medium, wherein the common descriptor includes formatting information in a standardized format that is sufficient to describe how the data is formatted, and
using the description of how the data is formatted in the common descriptor to read the data.

19. The method for reading data on a storage medium using a common descriptor format of claim 18, wherein the step of reading the common descriptor on the storage medium comprises the steps of:
read a subset of standards-based elements, wherein the subset of standards-based elements describes how the common descriptor is formatted, and
reading a set of vendor-specific formatting elements, wherein the vendor-specific formatting elements utilize standardized terms to describe vendor-specific formatting features for the data.

20. The method for reading a data file on a storage medium using a common descriptor format of claim 18, further comprising the step of determining whether data written in the format described in the common descriptor can be read.
